(19) United States
(12) Patent Application Publication
(10) Pub. No.: US 2010/0199931 A1
(43) Pub. Date: Aug. 12, 2010

(54) Portable handheld work apparatus having an internal combustion engine

(76) Inventors: Jan Kurzenberger, Kongen (DE); Thorsten Hecht, Durbheim (DE); Sebastian Hänssler, Stuttgart (DE); Stefan Kummermehr, Berglen (DE)

Correspondence Address: WALTER OTTESEN, PO BOX 4026, GAITHERSBURG, MD, 20885-4026, US

(21) Appl. No.: 12/658,399

(22) Filed: Feb. 9, 2010

(30) Foreign Application Priority Data
Feb. 9, 2009 (DE) 10 2009 008 055.4

(51) Int. Cl. F01P 7/02; F02F 1/06; F02G 5/00; F02B 77/02

(52) U.S. Cl. 123/41.65; 123/41.69; 123/556; 123/198 E

(57) ABSTRACT

In an internal combustion engine (2) of a portable handheld work apparatus, the cylinder (3) is provided with cooling ribs (4, 4′). A cooling airflow is generated by the fan wheel (13) and is guided over the cooling ribs. A carburetor (9) is temperaturized as required by the heated cooling air. A control of the cooling airflow to the carburetor (9) takes place in that an opening (11), which passes the heated cooling air, is selectively closed or opened via a closure element (12). In order to obtain improved cooling of the cylinder during summer operation as well as during winter operation, the closure element (12) is provided with at least one air guide wall which extends essentially transversely to the cooling airflow and causes this cooling air to be partially backed up and deflected.

### CROSS REFERENCE TO RELATED APPLICATION

This application claims priority of German patent application no. 10 2009 008 055.4, filed Feb. 9, 2009, the entire content of which is incorporated herein by reference.

### BACKGROUND OF THE INVENTION

U.S. Pat. No. 4,787,924 discloses a portable handheld work apparatus having an internal combustion engine wherein means are provided for setting a summer operation and a winter operation. The carburetor is mounted in a compartment covered by a filter element and two separate air inlet openings are provided for the inflow of combustion air. These inlet openings can be alternately opened or closed by a blocking wall. During summer operation, the blocking wall is so positioned that it closes an opening connecting the engine compartment to the carburetor compartment and clears an opening connected to the outside of the apparatus housing so that external air is supplied to the carburetor as combustion air. During winter operation, the opening to the outside is closed and the opening to the engine compartment is open so that air, which is heated by the cooling ribs of the engine, is supplied to the carburetor as combustion air. This publication is silent as to the cooling of the cylinder and the guidance of the cooling airflow at the cooling ribs.

### SUMMARY OF THE INVENTION

It is an object of the invention to provide a portable handheld work apparatus of the kind described above wherein an improved cooling of the cylinder is achieved during summer operation and winter operation.

The portable handheld work apparatus of the invention includes: an internal combustion engine having a cylinder provided with cooling ribs; a carburetor operatively connected to the engine; a fan wheel for generating a cooling airflow passing over the cooling ribs causing the cooling airflow to become a heated cooling airflow; a carburetor operatively connected to the engine; an opening passing the heated cooling airflow to the carburetor for temperaturizing the carburetor as may be needed; a closure element for selectively opening or closing the opening for controlling the heated cooling airflow to the carburetor; and, the closure element having an air guide wall extending substantially transversely to the heated cooling airflow so as to cause the heated cooling airflow to be at least in part backed up and deflected.

The arrangement of at least one air guide wall on the closure element achieves the condition that at least a component airflow is directed onto a side of the cylinder facing away from the fan wheel and, in this way, a uniform cooling over the periphery of the cylinder is provided. A further advantage is that the disassembly and the insertion of the closure element is facilitated by the manipulation thereof at the air guide wall.

A suitable configuration comprises that an intermediate wall is formed in a housing of the work apparatus. This intermediate wall partitions an engine compartment from a carburetor compartment. The opening for permitting the heated cooling air to pass through to the carburetor is provided in the intermediate wall. The direct passing of the heated air into the carburetor compartment is made possible in this way and additional air guiding channels are not needed. Preferably, the closure element is so configured that, in a selectable position, the cooling air is divided into a component airflow to the carburetor and a component airflow for charging the cooling ribs. In this way, an adequate heating of the carburetor as well as an adequate cooling of the cylinder is achieved on the side thereof facing away from the fan wheel.

The closure element is advantageously configured as an insert component. In this way, the assembly is especially easily possible and no additional fastening elements such as threaded fasteners, clamps or the like are needed. The insert component is configured to be elongated and has a center or mid section for selectively closing the opening and insert sections for attaching the insert component. Take-up fixtures are provided close to the opening into which the insert component can be inserted. These take-up fixtures each preferably include a slot wherein the insert sections are accommodated.

In order to avoid an unintended loosening of the insert component from the assumed position, it is advantageous that at least one latch projection is formed on the insert component which coacts with a latch hook held on the intermediate wall. According to a preferred embodiment of the invention, the insert component has an air guide wall on a longitudinal side thereof which extends essentially over the length of the insert component. This element is especially provided for summer operation. For the winter operation, it is advantageous that the insert component, on a longitudinal side, has a channel for conducting air of the component airflow to the carburetor. The channel is in overlapment with the opening in the mounted or installed position of the insert component. On this longitudinal side, it is practical to arrange a short air conducting wall next to the channel.

### BRIEF DESCRIPTION OF THE DRAWINGS

The invention will now be described with reference to the drawings wherein:

FIG. 1 is a cutaway view of a section through an internal combustion engine having a carburetor introduced into a housing;

FIG. 2 shows a closure element configured as an insert component for influencing an airflow path;

FIG. 3 is a cutaway detail view of the internal combustion engine and the insert component disposed in a first position;

FIG. 4 is an alternate view onto the insert component in the installed position of FIG. 3;

FIG. 5 is a detail view of FIG. 3 but with the insert component disposed in a second position; and,

FIG. 6 is an alternate view of the insert component in the installed position of FIG. 5.

### DESCRIPTION OF THE PREFERRED EMBODIMENTS OF THE INVENTION

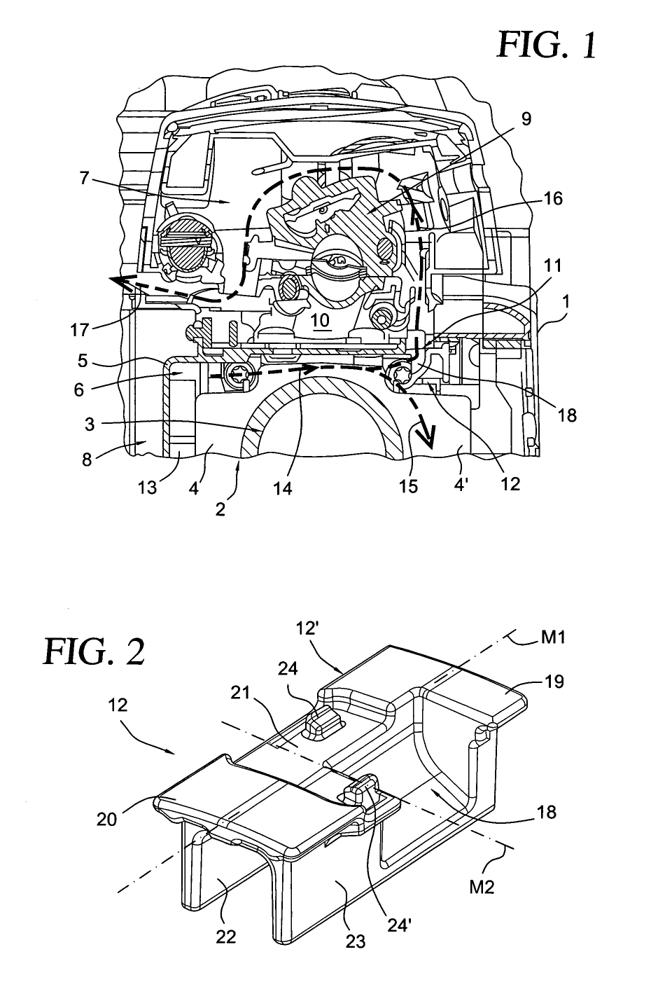

The section shown in FIG. 1 illustrates an internal combustion engine 2 having a cylinder 3 and with cooling ribs 4 formed on the cylinder. The engine 2 is built into a housing 1 of a portable handheld work apparatus. In the housing 1, an intermediate wall 5 extends next to the engine 2 and this wall partitions an engine compartment 6 from a carburetor compartment 7, a tank compartment 8 and, if needed, additional compartments. A carburetor 9 is arranged in the carburetor compartment 7. The carburetor 9 is connected by an intake stub 10 to an inlet opening (not shown in FIG. 1) for the combustion mixture.

An opening 11 is disposed in the intermediate wall 5 and a closure element 12 is arranged in the region of this opening. The closure element 12 can assume two different positions on the intermediate wall 5. In a first position, the opening 11 is cleared and, in a second position, the opening 11 is closed. The position with the cleared opening 11 is the “winter position” and the position with the closed opening 11 is the “summer position”. In FIG. 1, the winter position of the closure element 12 is shown and, accordingly, the opening 11 is cleared. In this way, the engine compartment 6 is connected to the carburetor compartment 7.

A cooling airflow 14 is generated by a fan wheel 13 attached to the engine shaft. The cooling airflow 14 charges the cooling ribs 4 of the engine and flows between the cylinder 3 and the intermediate wall 5. The cooling airflow 14 is heated by radiation of heat at the cooling ribs 4 and impinges upon the closure element 12. A component flow 16 is conducted to opening 11 via a channel 18 configured in the closure element 12 and is guided into the carburetor compartment 7. There, this component flow 16 of the heated cooling air flows about the housing of the carburetor 9 so that a temperature increase results and the combustion air, which flows through the carburetor 9, is likewise heated. The component flow 16 exits from the carburetor compartment 7 in accordance with arrow 17. A portion of this cooling airflow 14 backs up at an air conducting wall when striking the closure piece 12 and a component airflow 15 is deflected into the direction which makes possible a charging of the cooling ribs 4′ facing away from the fan wheel 13. The air guide wall will be explained in greater detail hereinafter. In this way, a uniform temperature distribution over the periphery of the cylinder 3 is achieved.

FIG. 2 shows a perspective view of the closure element 12 which is configured as insert component 12′ in the embodiment. The closure element 12 has a center axis M1 in its longitudinal direction and a center axis M2 in its transverse direction. On its upper side in FIG. 2, the insert component 12′ is provided with insert sections (19, 20) which are disposed on the narrow sides of the insert component 12′ and are somewhat elevated relative to a center section 21 of the insert component. Referred to the center axis M1, an air guide wall 22 runs on the longitudinal side of the insert component 12′ over the length between the insert sections (19, 20) and the channel 18 is configured on the other longitudinal side between the insert section 19 and the center axis M2 of the transverse direction and a short air guide wall 23 is arranged between the insert section 20 and the center axis M2. The air guide wall 23 runs parallel to the air guide wall 22 disposed on the other longitudinal side.

On the center section 21, two upwardly-directed latch projections (24, 24′) are provided which, referred to the center axes (M1, M2), are arranged at mirror images with respect to each other and, as will be explained hereinafter, function to ensure that the insert component 12′ remains securely in its mounted position.

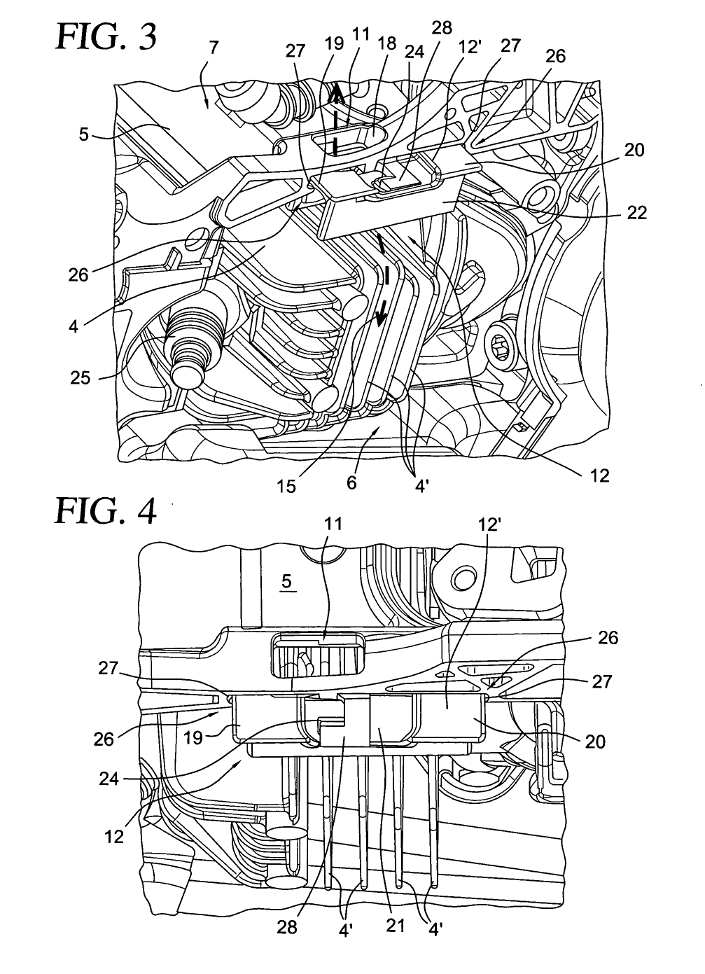

FIG. 3 shows a cutaway detail of a view of the internal combustion engine 2 having cooling ribs 4′ and a spark plug 25. The intermediate wall 5 is disposed above the engine 2 and partitions the engine compartment 6 from the carburetor compartment 7. The opening 11 is provided in the intermediate wall and this opening connects the engine compartment 6 to the carburetor compartment 7. In the region of the opening 11, receiving fixtures 26 are formed laterally next to the opening and these fixtures form opposite-lying slots 27 running parallel to the plane of the intermediate wall. The insert sections (19, 20) of the closure element 12 can be pushed into these slots 27 and, so far, until a latch hook 28 latches in behind the latch projection 24 and in this way reliably fixes the insert component 12′.

In the first position shown in FIG. 3 wherein the insert component 12′ is installed, the opening 11 is cleared in that the channel 18 is disposed in overlapment with the opening 11 and therefore the component flow 16 of the cooling airflow is conducted through the opening 11 into the carburetor compartment 7. The other component flow 15 is deflected by the short guide wall 23 (not shown in FIG. 3) to the cooling ribs 4.

FIG. 4 shows another view of the closure element 12 or insert component 12′ in the installed position in accordance with FIG. 3. The insert component 12′ is introduced with its insert sections (19, 20) into slots 27 of the receiving fixtures 26. The insert component 12′ is inserted so far that the latch hook 28 engages behind the latch projection 24. The reference numerals correspond to those in FIG. 3 for the same parts.

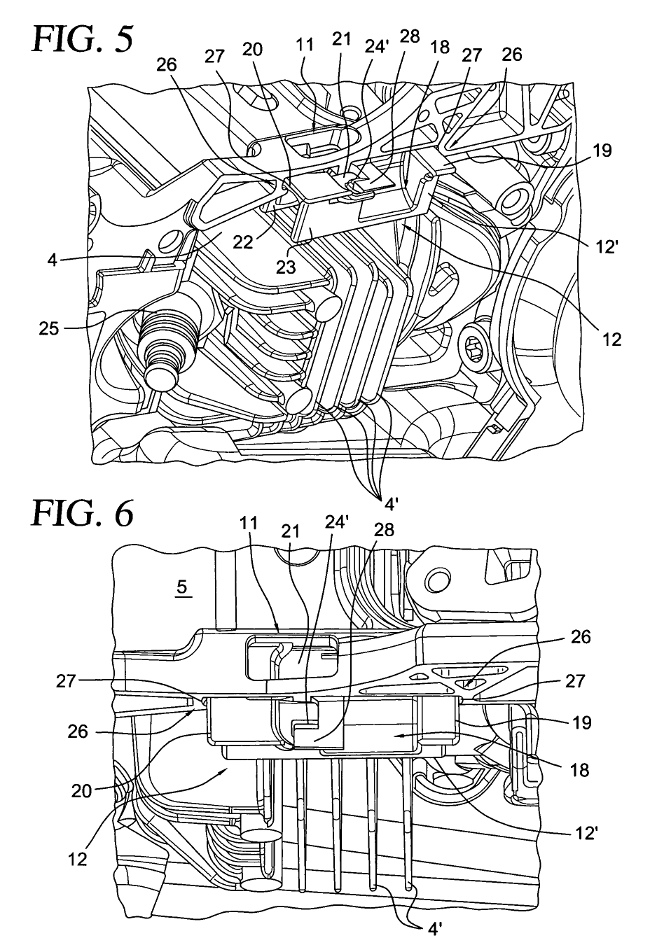

FIG. 5 shows a cutaway of a view of the engine 1 according to FIG. 3 but with a second position of the closure element 12 or insert component 12′. The insert component 12′ is pushed into the slots 27 of the receiving fixture 26 such that the air guide wall 22 faces toward the cooling airflow and the closure element 12 closes the opening 11. The channel 18 and the short air guide wall 23 are disposed on the side facing away from the cooling airflow and are therefore not functioning. In this installed position of the insert component 12′, the cooling airflow is almost completely deflected in the direction toward the cooling ribs 4′ and there is no dividing into the component flows described above. To secure the insert component 12′, the latch hook 28 grabs behind the latch projection 24′. The reference numerals in FIG. 5 correspond to those of FIG. 3 for the same parts.

FIG. 6 shows another view of the closure element 12 or insert component 12′ in the installed position according to FIG. 5. Compared to the first installed position shown in FIG. 4, the insert component 12′ is inserted into the slots 27 rotated 180° so that the insert component 12′ completely covers the opening 11 with the center section 21 and the bordering region directed toward the insert or end section 20 and thereby completely closes this opening 11. In this second installed position, the latch projection 24 is grabbed from behind by the latch hook 28 and, in this way, the insert component 12′ is fixed in its position. The parts of FIG. 6 which are the same as those in FIG. 5 have the same reference numerals.

To remove the closure element 12 or insert component 12′, the latch hook 28 is lifted and the insert component is pulled out of the slots 27 of the receiving fixture 26. For this purpose, the insert component 12′ can be grabbed in a simple manner at one of the air guide walls (22, 23) or at both air guide walls which facilitates manipulation. To insert the insert component 12′ into the other position, the component is rotated by 180° and is then pushed into the slots 27 with the insert sections (19, 20) so far until the latch hook 28 latches behind the corresponding latch projection 24 or 24′.

It is understood that the foregoing description is that of the preferred embodiments of the invention and that various changes and modifications may be made thereto without departing from the spirit and scope of the invention as defined in the appended claims.

What is claimed is:

1. A portable handheld work apparatus comprising:
an internal combustion engine having a cylinder provided with cooling ribs;
a carburetor operatively connected to said engine;
a fan wheel for generating a cooling airflow passing over said cooling ribs causing said cooling airflow to become a heated cooling airflow;
a carburetor operatively connected to said engine;
an opening passing said heated cooling airflow to said carburetor for temperaturizing said carburetor as may be needed;
a closure element for selectively opening or closing said opening for controlling the heated cooling airflow to said carburetor; and,
said closure element having an air guide wall extending substantially transversely to said heated cooling airflow so as to cause said heated cooling airflow to be at least in part backed up and deflected.

2. The portable handheld work apparatus of claim 1, further comprising a housing having an engine compartment for accommodating said engine therein and a carburetor compartment for accommodating said carburetor therein and having an intermediate wall separating said compartments from each other; and, said opening being disposed in said intermediate wall.

3. The portable handheld work apparatus of claim 1, wherein said closure element is mountable with respect to said opening in a selectable position and is configured so as to cause said heated cooling airflow to be split into a first component heated cooling airflow to said carburetor and a second component heated cooling airflow toward said cooling ribs.

4. The portable handheld work apparatus of claim 3, wherein said closure element is configured as an insert component.

5. The portable handheld work apparatus of claim 4, wherein said insert component is elongated and has a mid section for selectively closing said opening; and, said insert component further has first and second insert sections for attaching said insert component.

6. The portable handheld work apparatus of claim 5, further comprising receiving fixtures close to said opening into which said insert component can be inserted.

7. The portable handheld work apparatus of claim 6, wherein each of said receiving fixtures defines a slot for accommodating a corresponding one of said insert sections therein.

8. The portable handheld work apparatus of claim 4, wherein said insert component has at least one latch projection; and, wherein said apparatus further comprises a latch hook on said intermediate wall for coacting with said latch projection.

9. The portable handheld work apparatus of claim 5, wherein said insert component has a longitudinal side and an air guide wall on said longitudinal side which extends substantially over the length of said insert component.

10. The portable handheld work apparatus of claim 5, wherein said insert component is selectably mountable with respect to said opening in one of two positions; said insert component has a longitudinal side and a channel on said longitudinal side for conducting said first component heated cooling airflow to said carburetor; and, said channel is in overlapment with said opening in one of said two positions.

11. The portable handheld work apparatus of claim 10, wherein said longitudinal side of said insert component is a first longitudinal side and said insert component has a second longitudinal side next to said channel; and, said insert component further has a short air guide wall arranged next to said channel.
